(19) United States
(12) Patent Application Publication
(10) Pub. No.: US 2006/0228480 A1
(43) Pub. Date: Oct. 12, 2006

(54) METHOD OF MANUFACTURING A RELEASE LINER

(76) Inventor: David Lin, Shanhu (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/907,370

(22) Filed: Mar. 30, 2005

(51) Int. Cl. B05D 3/00

(52) U.S. Cl. 427/275; 156/219; 156/252

(57) ABSTRACT

The present invention relates to a method of manufacturing a release liner to be temporarily adhered to the surface of an adhesive. A single-layer or multi-layer film is obtained by impressing a plastic base liner substrate. At least one surface of the base liner substrate is coated with a release agent to form a tearable release liner. There is no fibrous debris along the edges when the release liner is torn apart.

### BACKGROUND OF THE INVENTION

1. Field of Invention

The present invention relates to release liner for adhered to surfaces of adhesive tapes, labels, or stickers and more particularly to a method of manufacturing release liners with improved characteristics (e.g., good tearablility, without causing fiber debris on torn edges, etc.)

2. Related Art

Conventionally, in order to provide a temporary protection to the adhesion property of the adhesive surface and to prevent a possible contamination to the adhesive surface, a release liner (e.g. release paper or release film) is commonly used to adhere to the adhesion surface of adhesive tapes, label stocks, or stickers for the protection of adhesive material thereof. At lease one surface of a release liner substrate is coated with release agent to provide a lower surface energy character. Typically, a release material is formed on the surface of the release paper to be adhered to the adhesive tape, label stock, or sticker. In addition to the protection purpose, the release paper is also easily peeled or torn prior to use.

The types of substrate for the release liner are comprised of super-calendered kraft paper mainly used by North American countries, glassine paper mainly used by European countries, polyolefin coated kraft paper mainly used by high humid countries including Japan and Taiwan. The other moisture resistance plastic films can also be used as a base substrates of liner due to their water resistance such as polyethylene (PE), polypropylene (PP), Mylar polyester (PET), polystyrene, polyvinyl chloride, and so on, which are becoming popular recently.

The use of paper release liner is a very old art. Paper based release liners have the benefit of being easily tearable. However, it may cause fiber debris when tearing. Such may contaminate the environment. Thus, it is not acceptable in a dust free or clean room environment (e.g., in electronic factories or hospitals). Again, the polyolefin coated release paper cannot be recycled causing a burden to the environment. The disadvantages of release paper include: 1) comparable higher paper substrate cost in regions with fewer forest resources; 2) difficult to separate and recycle both organic and inorganic components contained in release paper. In the real practice, in order to avoid curving of release paper due to ambient temperature and humidity, release paper substrate is usually polyolefin coated in one side or both sides of the same, by means of extrusion curtain coating of polyethylene (PE) as a side sealing treatment using T-die extruder, because it is hard to separate the coated polyolefin from the paper substrate for recycling purposes, burning is finally used.

For plastic based release liners, they have the benefit of without causing fiber debris when tearing. However, it is not easy to tear because the extendable feature of plastic film has resistance to tear. In many cases, a knife, scissors or the like is required to cut the plastic release film into the desired length. This is not convenient. Furthermore, for a soft substrate release liner, polyethylene, it is characteristic of high elongation and/or high draw ratio with a drawing. It cannot be easily torn. It also ruins the torn edges into a morphological uneven and rugged surface. Further, tear with great force may damage the protected adhesive tape, label stock, or sticker thereunder. Thus, continuing improvements in the method of manufacturing an easily tearable release liner without the above drawbacks are constantly being sought.

### SUMMARY OF THE INVENTION

It is therefore an object of the present invention to provide a method of manufacturing an easily tearable release liner to be temporarily adhered to the surface of an adhesive tape, label stock, or sticker. The material of the easily tearable release liner can be selected from a highly oriented plastic film with a higher mechanical strength, such as polyethylene terephthalate (PET), polypropylene (PP), polyethylene naphthalate (PEN), or the like, or biaxially-oriented or uniaxial-oriented plastic film, such as polymethylmethacylate (PMMA). This easily tearable release liner can be integrated to a double-sided adhesive tape. Both release liner and adhesive layer can be easily torn to have a segment of a desired length. The mechanical strength of this release film is strong enough for package applications and is adapted to be easily torn, and does not cause fiber debris when tearing and is acceptable in a dust free or clean room environment.

With this invention, it will cut down the demand of paper raw material from natural forest. The quality of this easily tearable plastic release liner is superior to the conventional paper release liner. It provides a uniform thickness, dimensional stability, and no curving deformation effect due to a less ???? moisture absorption. And it is an advantage for those countries lacking of natural forest and paper pulp. The easy tearable plastic release liner disclosed in the present invention has a more uniform thickness and is of better quality than conventional release paper. In addition, higher yield can be achieved during mass production lowering manufacturing costs.

In one aspect of the present invention, a release liner is manufactured by utilizing impression process to obtain a release liner being easily tearable to get a film of desired length. Many impression technologies can be applied in the manufacturing of easily tearable release liner substrate including a film substrate and an impression process for the formation of a plurality of micro-gaps. The impressed area can be selected as desired to form a randomly impressed pattern, or the whole area can be impressed. Both continuous-type impression cylinder roller sets and batch-type planar table-like impression machines are suitable for the impression process. The former, however, is more economical, and is more easily automated. The continuous-type impression cylinder assembly comprises an impression cylinder and one opposing cylinder. Both the cylinder roller set and planar table-like machine include an impresser and a transfer co-impresser. At least one of the two impressers comprises a plurality of fine protruding grains on the surface of the cylinder or plate (not shown). The protruding grains may be formed by using the following methods: 1) electroplating polyhedron diamond-like powders onto the surface of the impresser; 2) using a laser to engrave ceramic materials or metals formed on the surface of the impresser, such as anilox rolls; 3) using a mechanical tooling method and performing a surface hardening treatment, such as an annealing treatment or ultrasonic treatment, on the metal formed on the surface of the impresser, or plating a hard coating material on the surface of the impresser following a thermal treatment; 4) electrochemically etching and then performing a surface hardening treatment on the surface metal of the impresser. In addition, the opposing cylinder or plate, i.e. the co-impresser, is made of a metal with a relatively high hardness, such as steel, or ceramic.

It is appreciated that after executing the impression process, unlike the die cutting process, there is no weight loss on the film structures.

In another aspect of the present invention, a method of manufacturing a release liner to be easily torn is provided. The method comprises the steps of i) applying a release agent on at least one surface of a single-layer or multi-layer film substrate; ii) drying or performing a solidification reaction on the single-layer or multi-layer film; and iii) impressing the single-layer or multi-layer film by means of a impressing roller set to form a plurality of micro-gaps thereon, thereby forming a release liner with characteristic of being easily tearable.

By virtue of an impression manufacturing in liner thickness direction from the top face to the bottom face, it forms a plurality of normally substantially closed micro-gaps. Each of the micro-gaps comprises a split seam portion within the liner surface; two edges of the seam are physically contacted to each other. The impressed area can be selected as desired to form a partial impressed area, or throughout the whole area.

In yet another aspect of the present invention is to provide a release liner made of plastic material having a characteristic of being easily tearable as release paper without causing fiber debris.

The present invention resolves the problems cited in related arts by providing a substrate for easy tearable plastic release liner. In yet further aspect of this invention is to provide a plastic release liner that can be adapted in a wider range of temperature and the release agent can be coated on one surface to form a single-sided release liner or on both surfaces to form a double-sided release liner. Single-sided release liner can be used for protecting the adhesive surface of self-adhesion adhesive tape, label stocks or stickers; double-sided release liner can be used with easy tearable double sided adhesive tape rolls or stacking single sheets together.

The advantages of the easy tearable release liner obtained by the present invention include: 1) no fiber debris in torn edge, excellent for use in clean rooms; 2) can replace currently used release paper, which is hard to recycle; 3) variation of ambient temperature and humidity does not affect the thickness and length of the release liner in the present invention, while dry ambient can cause curving in paper substrates resulting in excessive loss during manufacturing of release paper; 4) it is also a benefit for those countries with fewer forest resources that the raw materials for the easy tearable plastic release liner in the present invention can be easily obtained without any restrictions, providing another alternative in release liner substrate that offers lower cost and better and more stable quality; 5) no additional release agent coating equipment for is needed, as the existing machinery can be used; 6) Manufacturing speed and yield are increased, as the release liner substrate in the present invention provides higher mechanical strength and a more uniform thickness.

It should be noted that the micro-gaps might have other shapes. Preferably, the shape of the micro-gaps is selected from groups consisting of linear shapes, conic shapes, pyramidal shapes, tetrahedral shapes, polygonal shapes, or cruciform shapes. Basically, the shape of the micro-gaps depends on the shape of the protruding grains on the surface of the cylinder or plate. The micro-gaps can be evenly distributed, or randomly distributed within the selected areas on the release liner surface.

In order to increase the anchor strength of the release agent during release agent coating process, the film substrates are surface treated by means of corona discharge treatment, flame treatment, plasma discharge, primer coating, etching, etc. Corona discharge treatment is the most commonly used method.

The above and other objects, features and advantages of the present invention will become apparent from the following detailed description taken with the accompanying drawings.

### BRIEF DESCRIPTION OF THE DRAWINGS

FIG. 1 is a flowchart depicting a process for manufacturing a release liner according to a first preferred embodiment of the invention;

FIG. 2 schematically shows steps of the process in FIG. 1;

FIG. 3 is a flowchart depicting a process for manufacturing a release liner according to a second preferred embodiment of the invention;

FIG. 4 schematically shows steps of the process in FIG. 3;

FIG. 5 is a flowchart depicting a process for manufacturing a release liner according to a third preferred embodiment of the invention; and

FIG. 6 schematically shows steps of the process in FIG. 5.

### DETAILED DESCRIPTION OF THE INVENTION

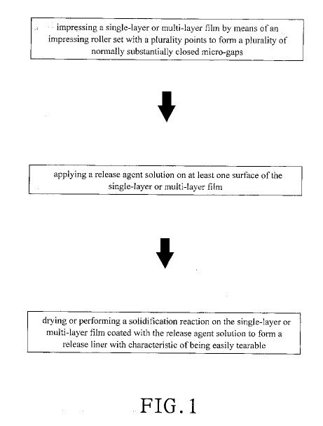

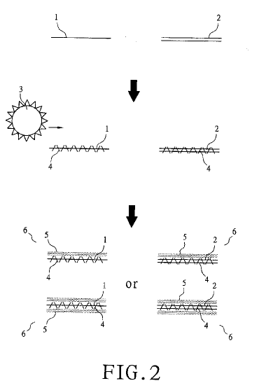

Referring to FIGS. 1 and 2, a process for manufacturing an easily tearable release liner according to a first preferred embodiment of the invention is illustrated. In a first step impress a single-layer film 1 or multi-layer film 2 by means of an impressing roller set 3 (e.g., wire brush or needle roller) to form a plurality of micro-gaps 4 in a portion area or whole area of the single-layer film 1 or multi-layer film 2. In a second step apply a release agent 5 on either one surface of the single-layer film 1 or multi-layer film 2 or both surfaces of the single-layer film 1 or multi-layer film 2. In a third final step dry or perform a chemical crosslinking reaction on the single-layer film 1 or multi-layer film 2 to form a release liner 6 with characteristic of being easily torn. The drying for films coated with emulsion waterborne or solvent base release agent solution can be carried out by means of a typical heating compartment with a circulating hot air or an advanced air floating drying process. The curing for films coated with solventless release agent solution can be carried out by a radiation curing process, such as ultraviolet (UV) or electron beam (EB) reaction, to solidify the release agent 5 to form a easily tearable release liner 6.

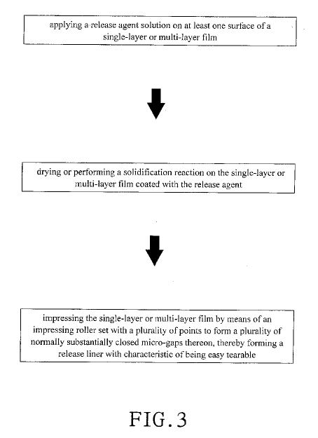

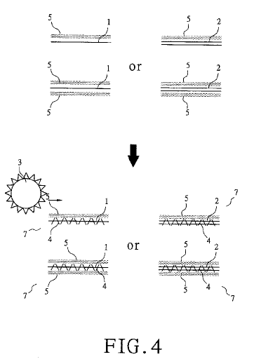

Referring to FIGS. 3 and 4, a process for manufacturing release liner according to a second preferred embodiment of the invention is illustrated. In a first step apply the release agent 5 on either one surface of the single-layer film 1 or multi-layer film 2 or both surfaces of the single-layer film 1 or multi-layer film 2. In a second step dry or perform a chemical crosslinking reaction on the single-layer film 1 or multi-layer film 2. The drying for the film coated with emulsion waterborne or solvent base release agent solution can be carried out by means of a typical heating compartment with a circulating hot air or an advanced air floating drying process. The drying for films coated with non-solvent release agent solution can be carried out by radiation curing reaction, such as ultraviolet (UV) or electron beam (EB) reaction. In a third final step impress the single-layer film 1 or multi-layer film 2 by means of a impressing roller set 3 to form a plurality of micro-gaps 4 in a portion area or whole area of the single-layer film 1 or multi-layer film 2 to form a release liner 7 with characteristic of being easily tearable.

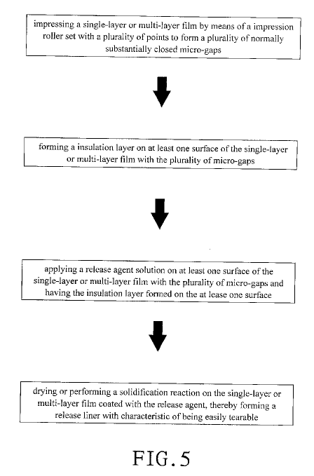

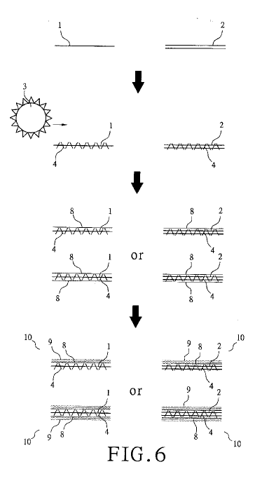

Referring to FIGS. 5 and 6, a process for manufacturing release liner according to a third preferred embodiment of the invention is illustrated. In a first step impress a single-layer film 1 or multi-layer film 2 by means of the impressing roller set 3 to form a plurality of micro-gaps 4 in a portion are or whole area of the single-layer film 1 or multi-layer film 2. In a second step an additional insulation layer 8 on either one surface of the single-layer film 1 or multi-layer film 2 or both surfaces of the single-layer film 1 or multi-layer film 2 by means of lamination, coating or extrusion. In detail, the insulation layer 8 can be performed by one of the following methods. (i) Laminate plastic layers having characteristic of less mechanical strength such as one selected from PE, PP, or PE and PP coextruded film of low elongation characteristic on the surface of the film. (ii) Coat an organic, inorganic, oxide or a mixture of sealant formulation, the material (e.g., polymeric material) selected from acrylic resin, stylene-butadiene copolymer, starch and amyloid material, agar, gelatin, wax, fatty acid and its derivatives, or surfactant on the surface of the film. The sealant material is then subjected to a coating process performed by gravure coater, meyer bar, coma coater, dipping, roller, or air knife prior to forming a insulation layer 8. (iii) Coextruded a hot melt material selected from thermal plastic PE, PP, hot melt adhesive, polyvinyl acetate, wax or a combination thereof. Preferably, an extruded hot melt adhesive is adopted. Prior to coating the hot melt adhesive, an anchor tie layer primer coating is recommended for increasing adhesion strength between the substrate and the hot melt material. Either corona treatment or primer coating may be performed prior to coating depending on applications. Primer solution can be applied either one liquid type or a dual liquid type. T-150/T-122 ethyl acetate solution is a two liquid type primer anchor solution; it is advantageous for improving the surface adhesion of PET, oriented polypropylene (OPP), or nylon film. Next, solution is coated with a 150 mesh gravure coater on the film prior to a hot melt coextruded with the hot melt adhesive such as PE or Polyvinyl acetate. Finally, perform a chemical post curing treatment at 40° C. for one to three days. In a third step, apply the release agent 9 either on the insulation layer 8 on one surface of the single-layer film 1 or multi-layer film 2 or on the insulation layer 8 on both surfaces of the single-layer film 1 or multi-layer film 2. In a fourth final step, dry or perform a chemical crosslinking reaction on the single-layer film 1 or multi-layer film 2. The drying for the film coated with emulsion waterborne or solvent base release agent solution can be carried out by means of a typical heating compartment with a circulating hot air or an advanced air floating drying process. The curing for films coated with solventless release agent solution can be carried out by radiation curing reaction, such as ultraviolet (UV) or electron beam (EB) reaction to solidify the release agent 9 to form a easily tearable release liner 1 0.

The base substrate can be selected from a group of polyethylene terephthalate (PET), biaxially oriented polypropylene (BOPP), high density polyethylene (HDPE), low density polyethylene (LDPE), coextruded polyolefin film, polystyrene (PS), polypropylene synthetic paper or polyethylene synthetic paper etc.

Alternatively, the base substrate can be selected from a high temperature resistance, high chemical resistance, solvent resistance materials such as polyethylene naphthalate (PEN), polyether ether ketone (PEEK), polycarbonate (PC), polyimide (PI), polysulfone, polyacrylonitrile (PAN), styrene acrylonitrile (SAN), polyurethane (PU), nylon, co-extrusion stretched film, composite film, or inorganic powder blended plastic film.

The tearable release liner of the invention has the following advantages. It is easy to tear and does not cause fiber debris. Consistent in uniform thickness can be formed. The effect of temperature and humidity on the liner dimensional stability is quite low as compared with a paper. It has excellent flatness and is easy to be processed. It is excellent in die cuttability. It is low cost and recyclable and has heatproof-ness and diverse applications.

The release agent can be selected from the following depending on the degree of release force. (i) Silicone release agent for providing prime release to medium release force. (ii) Non-silicone release agent comprises chromium complexes such as fluorochemical chromium complex; long side chain polymer such as polyvinyl octadecyl carbamates acrylate copolymer; and fluorochemical low adhesion backside such as fluorochemical side chain polymer. (iii) Organo-modified silicones. (iv) Hot melt additives release agent.

Release liner with different release force level:

Prime release, the release force is about 5-15 g/in.

Medium release or modified release system, the release force is about 15-150 g/in. For double-side adhesive tapes, release agents of different release forces are applied to both surfaces thereof.

For high release, the release force is about 120-500 g/in.

For drying or performing a chemical curing reaction on the release agent coated on the base liner substrate, a reaction catalyst, platinum, rhodium, or tin based catalysis system is optionally employed in release agent solution, and the means of reaction can be:
Condensation reaction—solution can be an emulsion waterborne or solvent base;
Addition reaction solution can be emulsion waterborne, solvent base or solventless;
Radiation reaction—solventless solution is commonly used, ultraviolet radiation (UV) and electron beam (EB) are commonly used radiation source.

The initiation reaction of the above mentioned reactions can be a free radical initiated reaction, cationic initiated reaction, ene-thiol reaction, hybrid initiated reaction etc.

Different types of release agent solution, emulsion base and solventless, are available from Dow corning (Syl-Off), GE Silicones, Shin-Etsu, Wacker Silicones etc.

Release liner coating methods of the invention is selective upon the type of solution and the viscosity of release agent solution:
(i) For solvent base solution: gravure coater, coma coater, dipping, and meyer bar;
(ii) For waterborne solution: gravure coater, coma coater, dipping, air knife, and meyer bar; and
(iii) For solventless solution: 3 or 5 roll coater and offset gravure coater.

### First Embodiment

Base substrates of KBOPP/AC/PE film and KPET/AC/PE film are employed. Shin-Etsu solvent bas silicone release agent solution, KS-3703/KS-3800 is a release agent and toluene is a solvent. The prime silicone release agent and the solvent are mixed in three to one ratio prior to adding 2% CAT-PL-50T platinum catalyst. Use No. 8 meyer bar to coat the prepared release agent solution on corona treated surface of the PE film, KBOPP and KPET films. Next, heat the same in a heating compartment at 100° C. for one minute. Amount of coated silicone is 0.8 g/m². Age the same at 25° C. with a relative humidity of 60% for one day. Pick up a 1″ wide release liner strip sample from the prepared material and stick with a 1″ Tesa7454 adhesive tape on the surface with release agent coated thereon. Adhere the surface of non-silicone coated release liner to a flat 304 stainless steel test plate via a double-side adhesive tape. Roll the same two times with a 2 Kg rubber roller. Keep the same at a constant normal pressure condition of 20 g/m² at 70° C. Next, measure release force (in unit of g/inch) of the release film on the zero hour and on the 1st and 7th day after the test day respectively by means of a universal tensile tester in 180 degrees peel angle with a peel speed of 12 inches per minute. Moreover, peel the release film in 180 degrees peel angle with a constant peel speed of 12″ per minute in which peeling force (in unit of g/inch) measured on different days are tabulated in Table I:

TABLE I
Release force and peeling force measured on release films produced by
using different base substrates with solvent base silicone
release agent in 0, 1 and 7 days

| | Test | | |
|---|---|---|---|
| | Release | Release | Release |
| | force/peeling | force/peeling | force/peeling |
| | force (g/in) | force (g/in) | force (g/in) |
| | measured on | measured on the | measured on |
| materia | zero hour | 1st day | the 7th day |
| KBOPP/AC/PE film/ | 11/33 | 14/33 | 8/33 |
| release agent | | | |
| KPET/AC/PE film/ | 10/41 | 15/42 | 9/42 |
| release agent | | | |
| PE film/AC/KBOPP/ | 16/33 | 15/33 | 11/33 |
| release agent | | | |
| PE film/AC/KPET/ | 21/42 | 19/42 | 15/42 |
| release agent | | | |

KBOPP/AC/PE film represents 25 μm impressed biaxially oriented polypropylene/5 μm AC/25 μm t-die extrusion coated PE film; KPET/AC/PE film represents 25 μm impressed KPET film/5 μm AC/25 μm t-die extrusion coated PE film; and AC represents anchor coating.

### Second Embodiment

Base substrates of KBOPP/AC/PE film and KPET/AC/PE film are employed. A low temperature cured Shin-Etsu silicone release agent solution, KS-847T is solvent base, and toluene is as a solvent. Both release agent solution and the solvent are mixed prior to adding 2% CAT-PL-50T platinum catalyst. Use No. 8 meyer bar to coat the prepared release agent formulation solution on the corona treated PE, KBOPP and KPET surfaces of the base release liners. Next, heat the same in a heating compartment at 90° C. for one minute for curing. Amount of coated silicone is 0.7 g/m². Age the same at 25° C. with a relative humidity of 60% for one day. Pick up a 1″ wide release liner strip sample from the prepared material and stick with a 1″ wide Tesa7454 adhesive tape on the surface with release agent coated thereon. Adhere the surface of the non-silicone coated release liner to a flat 304 stainless steel test plate via a double-side adhesive tape. Roll the same two times with a 2 Kg rubber roller. Keep the same at a constant normal pressure condition of 20 g/m² at 70° C. Next, measure release force (in unit of g/inch) of the release liner at the zero hour and on the 1st and 7th day after the test day respectively by means of a universal tensile tester in 180 degrees peel angle with a peel speed of 12″ per minute. Moreover, peel the release liner in 180 degrees peel angle with a constant peel speed of 12″ per minute in which peeling force (in unit of g/inch) measured at different days are tabulated in Table II:

TABLE II
Release force and peeling force measured on release liners produced
by using different base substrates with low temperature cure solvent
base silicone release agent in 0, 1, and 7 days

| | Test | | |
|---|---|---|---|
| | Release | Release | Release |
| | force/peeling | force/peeling | force/peeling |
| | force (g/in) | force (g/in) | force (g/in) |
| | measured on | measured on the | measured on |
| materia | the zero hour | 1st day | the 7th day |
| KBOPP/AC/PE film/ | 25/33 | 15/33 | 25/34 |
| release agent | | | |
| KPET/AC/PE film/ | 26/42 | 16/43 | 30/43 |
| release agent | | | |
| PE film/AC/KBOPP/ | 23/35 | 15/35 | 30/38 |
| release agent | | | |
| PE film/AC/KPET/ | 31/42 | 20/41 | 30/41 |
| release agent | | | |

KBOPP/AC/PE film represents 25 μm impressed biaxially oriented polypropylene/5 μm AC/25 μm t-die extrusion coated PE film; KPET/AC/PE film represents 25 μm impressed KPET film/5 μm AC/25 μm t-die extrusion coated PE film; and AC represents anchor coating.

### Third Embodiment

Base substrates of KBOPP/AC/PE film and KPET/AC/PE film are employed. Al wt % of polyvinyl octadecyl carbamate non-silicone release agent solution. The release agent and the toluene solvent are mixed prior to coating the prepared solution on the corona treated PE, KBOPP and KPET surfaces of the base release liners by No. 150 mesh gravure coater. Next, heat the same in a heating compartment at 100° C. for one minute. Amount of coated weight is 0.07 g/m². Dry the same in 65° C. with humidity of 60% for one day. Pick up a 1″ wide release liner strip sample from the prepared material and stick with a 1″ wide Tesa7454 acrylic adhesive tape and WQ4012 rubber adhesive tape on the surface with release agent coated thereon. PSTC-6 test method is applied: measure release force (in unit of g/inch) of the release liner by means of a universal tensile tester in 180 degrees peel angle with a peel speed of 0.3 m per minute and 50 m per minute respectively at different temperatures as tabulated in Table III, IV, and V:

TABLE III
Release force measured with acrylic adhesive tape and rubber adhesive
tape from the release agent coated surface of PE/AC/KBOPP/release
agent coated liner at different peel speeds and different temperatures

| | | Test adhesive | Release force (g/in) | | |
|---|---|---|---|---|---|
| Peel speed | | tape | 25° C. | 40° C. | 50° C. |
| 0.3 | m/min | Tesa7475 | 18 | 20 | 22 |
| | | WQ4012 | 105 | 124 | 155 |
| 50 | m/min | Tesa7475 | 31 | 35 | 38 |
| | | WQ4012 | 250 | 295 | 329 |

TABLE IV
Release force measured with acrylic adhesive tape and rubber adhesive
tape from the release agent coated surface of PE/AC/KPET/release
agent coated liner at different peel speeds and different temperatures

| | | Test adhesive | Release force (g/in) | | |
|---|---|---|---|---|---|
| Peel speed | | tape | 25° C. | 40° C. | 50° C. |
| 0.3 | m/min | Tesa7475 | 29 | 33 | 47 |
| | | WQ4012 | 195 | 229 | 1297 |
| 50 | m/min | Tesa7475 | 48 | 54 | 60 |
| | | WQ4012 | 371 | 439 | 566 |

TABLE V
Release force measured with acrylic adhesive tape and rubber adhesive
tape from the release agent coated surface of KBOPP/PE/release
agent coated liner at different peel speeds and different temperatures

| | | Test adhesive | Release force (g/in) | | |
|---|---|---|---|---|---|
| Peel speed | | tape | 25° C. | 40° C. | 50° C. |
| 0.3 | m/min | Tesa7475 | 17 | 18 | 20 |
| | | WQ4012 | 95 | 112 | 129 |
| 50 | m/min | Tesa7475 | 31 | 32 | 39 |
| | | WQ4012 | 206 | 219 | 307 |

An advantageous of the present invention is that the base substrate of the release liner is selected from a higher mechanical strength plastic and a higher draw-ratio film and thus is not easy to be ripped during the manufacturing process. When this easily tearable release liner is integrated to the adhesive tapes, label stocks or stickers, the release liner has tearablility as paper but does not cause fiber debris. Thus, it is acceptable application in a dust free, clean room, or a product assembly line environment. Another advantageous of the present invention is that the release force of release liner manufactured according to the present invention is flexible designed upon requirement by controlling impressing micro-gap density and times and selecting the material of the release agent and base substrate.

While the invention herein disclosed has been described by means of specific embodiments, numerous modifications and variations could be made thereto by those skilled in the art without departing from the scope and spirit of the invention set forth in the claims.

What is claimed is:

1. A method of manufacturing a release liner, comprising steps of:
i) impressing a single-layer or multi-layer film by means of a impressing roller set with a plurality points to form a plurality of normally substantially closed micro-gaps thereon;
ii) applying a release agent solution on at least one surface of the single-layer or multi-layer film; and
iii) drying or performing a solidification reaction on the single-layer or multi-layer film coated with the release agent solution to form a release liner with characteristic of being easily tearable.

2. The method of claim 1, wherein the single-layer or multi-layer film is selected from biaxial oriented polypropylene (BOPP), polyethylene terephthalate (PET), polyethylene naphthalate (PEN), polyether ether ketone, (PEEK), polycarbonate (PC), polysulfone, polysulfone, polyimide (PI), polyacrylonitrile (PAN), styrene acrylonitrile (SAN), polyurethane (PU), nylon, polyethylene (PE), polypropylene (PP), polyamide, ethylene-styrene copolymer (ES), cyclo olefin, polyvinyl alcohol (PVA), ethylene-vinyl acetate (EVA), styrene acrylonitrile copolymer (SAN), ionomer, synthetic paper, or a combination thereof.

3. The method of claim 1, wherein the release agent is selected from silicone, silicone derivative, or non-silicone type release agent.

4. The method of claim 3, wherein the non-silicone type release agent is selected from fluorochemical, long side chain polymer, chromium complexes, or a derivative thereof.

5. A method of manufacturing a release liner, comprising steps of:
i) applying a release agent solution on at least one surface of a single-layer or multi-layer film;
ii) drying or performing a solidification reaction on the single-layer or multi-layer film coated with the release agent; and
iii) impressing the single-layer or multi-layer film by means of a impressing roller set with a plurality of points to form a plurality of normally substantially closed micro-gaps thereon, thereby forming a release liner with characteristic of being easy tearable.

6. The method of claim 5, wherein the single-layer or multi-layer film is selected from biaxial oriented polypropylene (BOPP), polyethylene terephthalate (PET), polyethylene naphthalate (PEN), polyether ether ketone, (PEEK), polycarbonate (PC), polysulfone, polyimide (PI), polyacrylonitrile (PAN), styrene acrylonitrile (SAN), nylon, polyethylene (PE), polypropylene (PP), polyamide, ethylene-styrene copolymer (ES), cyclo olefin, polyvinyl alcohol (PVA), ethylene-vinyl acetate (EVA), styrene acrylonitrile copolymer (SAN), polyurethane (PU), ionomer, synthetic paper, or a combination thereof.

7. The method of claim 5, wherein the release agent is selected from silicone, silicone derivative, or non-silicone type release agent.

8. The method of claim 7, wherein the non-silicone type release agent is selected from fluorochemical, long side chain polymer, chromium complexes, or a derivative thereof.

9. A method of manufacturing a release liner, comprising steps of:
i) impressing a single-layer or multi-layer film by means of a impression roller set with a plurality of points to form a plurality of normally substantially closed micro-gaps thereon;
ii) forming a insulation layer on at least one surface of the single-layer or multi-layer film with the plurality of micro-gaps;
iii) applying a release agent solution on at least one surface of the single-layer or multi-layer film with the plurality of micro-gaps and having the insulation layer formed on the at lease one surface; and
iv) drying or performing a solidification reaction on the single-layer or multi-layer film coated with the release agent, thereby forming a release liner with characteristic of being easily tearable.

10. The method of claim 9, wherein the single-layer or multi-layer film is selected from biaxial oriented polypropylene (BOPP), polyethylene terephthalate (PET), polyethylene naphthalate (PEN), polyether ether ketone, (PEEK), polycarbonate (PC), polysulfone, polyimide (PI), polyacrylonitrile (PAN), styrene acrylonitrile (SAN), polyurethane (PU), nylon, polyethylene (PE), polypropylene (PP), polyamide, ethylene-styrene copolymer (ES), cyclo olefin, polyvinyl alcohol (PVA), ethylene-vinyl acetate (EVA), styrene acrylonitrile copolymer (SAN), polyurethane (PU), ionomer, synthetic paper, or a combination thereof.

11. The method of claim 9, wherein the release agent is selected from silicone, silicone derivative, or non-silicone type release agent.

12. The method of claim 11, wherein the non-silicone type release agent is fluorochemical, long side chain polymer, chromium complexes, or a derivative thereof.

13. The method of claim 9, wherein the insulation layer is selected from acrylic resin, polyester, polyethylene (PE), polypropylene (PP), polyimide, nylon, polyethylene-styrene copolymer, ethylene-styrene copolymer (ES), cyclo olefin, polyvinyl alcohol (PVA), ethylene-vinyl acetate (EVA), ionomer, epoxy resin, polycarbonate (PC), polysulfone, polyacrylonitrile (PAN), styrene acrylonitrile (SAN), styrene-butadiene copolymer, hot melt adhesive, polyurethane (PU), synthetic paper, or a combination thereof with characteristic of low stretch.

14. The method of claim 9, wherein the insulation layer is selected from starch and amyloid materials, agar, gelatin, wax, fatty acid and its derivatives, surfactant, or a combination thereof with characteristic of low stretch.

15. The method of claim 9, wherein the insulation layer is formed by laminating, solution coating and drying, or hot melt extrusion coating.
